(19) United States
(12) Patent Application Publication
(10) Pub. No.: US 2005/0056060 A1
(43) Pub. Date: Mar. 17, 2005

(54) Washing machine with improved washing-aid dispenser

(76) Inventor: Mirko Cenedese, Susegana (IT)

Correspondence Address: PEARNE & GORDON LLP, 1801 EAST 9TH STREET, SUITE 1200, CLEVELAND, OH, 44114-3108, US

(21) Appl. No.: 10/472,014

(22) PCT Filed: Apr. 29, 2002
(86) PCT No.: PCT/EP02/04707

(30) Foreign Application Priority Data
May 10, 2001 (IT) PN2001A000036

(51) Int. Cl. B08B 3/12

(52) U.S. Cl. 68/12.18; 68/3 R; 68/17 R; 68/208

(57) ABSTRACT

The compartments (4,5) of the dispenser are connected in series through a partition (9), while only one (4) of them is connected directly to a water inlet valve (11). During respective phases of operation, the valve (11) lets into the first compartment (4) variable amounts and/or flow-rates of water that can be caused to selectively flow over into at least another one of the compartments through the respective partition.

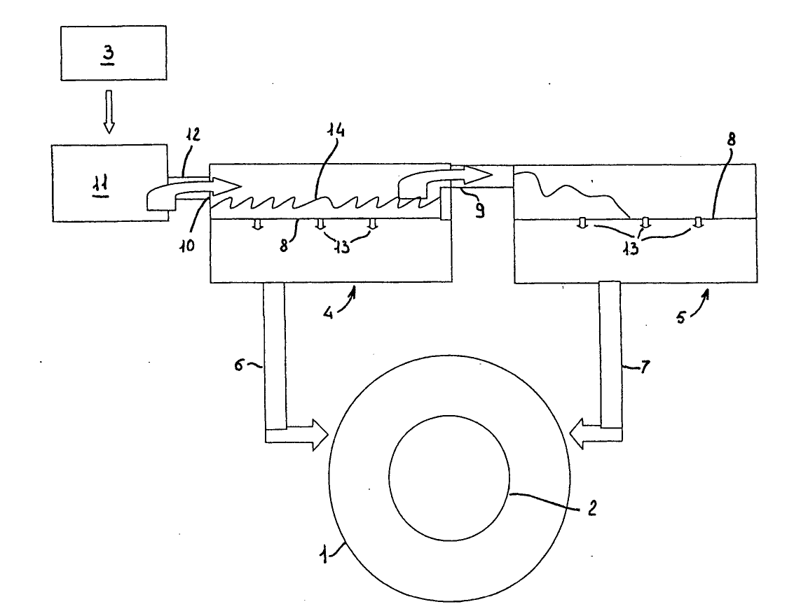

The present invention refers to a washing machine, such as a clothes washing machine, a combined clothes washing and drying machine, or the like, comprising an arrangement for dispensing such washing aids as for instance detergent, fabric softener, bleaching agent and the like.

Washing machines of the above cited kind are generally known to usually comprise a tub adapted to hold, usually inside a rotating drum accommodated therein, the clothes that can be treated with water in which, in respective operational phases of the process, various laundering aids are diluted.

Generally, such laundering aids are let into the tub of the machine through an appropriate dispenser, which can for example be of the pull-out drawer type, comprising adjacent and separate compartments (eg. three such compartments for holding the pre-wash detergent, the main wash detergent and the rinsing aid or fabric softener, respectively) in which respective metered amounts of various such laundering aids can be filled, according to the selected operation cycle of the machine.

From DE 9 103 486 U a washing machine with a dispenser is known, in which the detergent compartments are supplied with respective water ducts and relevant valves, and a siphon is provided between two compartments; however said solution is expensive due to a plurality of water ducts and relevant valves, and also not effectively working due to the low water pressure in the siphon working.

From DE 1 246 655 B a washing machine with a dispenser is known; as above, the detergent compartments are supplied with respective water ducts and relevant valves, and so offer the same drawback.

Furthermore the “prechambers 23, 24” are nowadays useless, due to the present reliability of the water valves.

It therefore is a purpose of the present invention to provide a washing machine equipped with an improved washing-aid dispenser arrangement that turns out in this way as being particularly simple, reliable and low-cost in its construction and operation.

According to the present invention, these and further aims are reached in a washing machine with a washing-aid dispenser embodying the characteristics as recited and defined in the appended claims.

Anyway, features and advantages of the present invention may be more readily understood from the description that is given below by way of non-limiting example with reference to the single accompanying drawing, which is a schematic view of the main operating component parts of the machine according to a preferred embodiment of the present invention.

With reference to the above-mentioned FIGURE, the washing machine is for example an automatic clothes washing machine controlled by a programme sequence control unit 3, which may for instance comprise a Motorola HCSO5 or a similar microprocessor.

Within an outer casing (not shown in the FIGURE), the washing machine comprises mainly a washing tub 1 accommodating a clothes-holding drum 2 that is adapted to rotate at different speeds, ie. revolution rates, to sequentially perform successive washing, rinsing, spin-drying and similar operating phases of a laundering process.

The washing machine further comprises a dispenser arrangement for holding washing products and/or rinsing aids, bleaching agents, and the like, in which said dispenser arrangement may for instance be of the pull-out drawer kind with two or more differentiated compartments (only two of which are however shown in the FIGURE for reasons of greater simplicity, and are generally indicated at 4 and 5, respectively).

For instance, the compartments 4 and 5 of the dispenser are adapted to hold metered amounts of detergent product for the pre-wash and the main wash phase of the process, respectively, in view of enabling said amounts of washing product to be let in a generally known manner into the washing tub 1 in successive phases. To such a purpose, the bottom portion of said compartments 4 and 5 is connected to the washing tub 1 via conduits 6, 7 that may be either distinct (as shown in the FIGURE) or substantially common.

In a preferred (and per sè known) manner, each one of said compartments 4 and 5 comprises a sieve-like wall 8, on which the respective metered amount of laundering aid, ie. washing powder in the example being described, is placed. Again in a per se known manner, each such wall 8 is provided with apertures, schematically indicated at 13, for the water to pass therethrough, in which these apertures have a pre-determined water-passage cross-section area altogether.

According to a feature of the present invention, the compartments 4 and 5 of the washing-aid dispenser are connected in series with each other, upstream of the respective walls 8, via at least a free connection 9 that preferably comprises a simple partition having a pre-determined overflow level.

Furthermore, only one of these compartments connected in series with each other (ie. the compartment 4 in the example being described) is connected is a substantially direct manner to the water supply mains 12, in correspondence of an inlet aperture 10 of the dispenser. The water supply mains 12 is provided with at least a valve means 11 (eg. an electromagnetic valve) controlled by the programme sequence control unit 3 of the machine in the manner that will be illustrated in greater detail further on in this description.

When a pre-wash phase must be carried out, the valve 11 is actuated so as to open for a pre-determined overall period of time and/or for a pre-determined amount or flow-rate of water to be let therethrough, as duly calculated by the design engineer skilled in the art in accordance with the actual sizing of the various water-carrying parts, in such a manner as to allow an amount of water (schematically indicated at 14 in the FIGURE) to be let into said compartment 4 that will not be able to flow over the partition 9 into the next compartment 5. As a result, the water that is in this way let into the compartment 4 of the dispenser will convey, via the perforations 13 of the wall 8 and the conduit 6, the pre-wash product into the washing tub 1 of the machine.

For the subsequent operating phase of the cycle (ie. the main wash in the example being described) to be then carried out, the valve 11 is actuated by the programme sequence control unit 3 of the machine to open for a longer overall period of time and/or for a greater amount or flow-rate of water to be let therethrough, such as to allow an amount of water to be let into said compartment 4 that will be able to flow over the partition 9 into the next compartment 5. As a result, the water that flows in this way over the partition 9 will convey into the washing tub 1 of the machine, via the perforations 13 of the wall 8 and the conduit 7, the washing product filled in the compartment 5.

It stands as a matter of course that part of the water that is in this case let into the compartment 4 (which is not holding any washing aid in this phase) will directly flow into the washing tub 1 through the conduit 6.

In conclusion, by using a single water-supply valve means 11, and by appropriately controlling such a valve means in the above-described manner, it is possible for the laundering aids filled in the various compartments 4, 5 of the dispenser to be selectively flushed off into the washing tub 1 at different moments.

It will be appreciated that this same concept may be applied to a laundering-aid dispenser arrangement comprising more than two compartments connected in series with each other, according to the needs, and/or the above-described operation phases (and the type of laundering product or aid associated therewith) may be different.

For the amounts of water being let into the washing-aid dispenser to be capable of being selectively controlled more accurately and in such a manner as to more effectively meet the actual needs or requirements, it is preferable that the valve means 11 is adapted to be so controlled as not to simply open for a certain period of time, but rather according to a so-called, selectively variable duty-cycle of successive openings and closures of the valve means itself. To such a purpose, for example, the programme sequence control unit 3 of the machine may be so set as to be adapted to control the valve means 11 with a 30-percent duty-cycle during the pre-wash phase, so as to let into the compartment 4 of the dispenser an appropriate amount of water that will not overflow into the next compartment 5. During the main wash phase, on the contrary, the programme sequence control unit 3 of the machine will be able to control the valve means 11 with, say, a 90-to-100-percent duty-cycle, in such a manner as to cause the water to be let into the compartment 4 of the dispenser in such an amount as needed for it to be able to overflow into the next compartment 5 (or in the next compartments, as the case may be).

According to a further variant, the valve means 11 may be of the type provided with a controllable, or variable, water-passage cross-section area, so as to be able to suitably vary the flow-rate of the water being let into the compartment 4, under control of the programme sequence control unit 3 of the machine, so as to ultimately bring about a kind of operation giving an overall result that is fully similar to the afore described one.

In any case, the washing machine according to the present invention turns out as being simplified to a substantial extent thanks to the elimination of a number of controlled-type valve means and the related control electronics. In particular, both the flow rate and the amount of the water that flows through the valve means 11 can be advantageously controlled by the programme sequence control unit of the machine, in a particularly flexible and reliable manner, through the use of a software that is not a part of the present invention.

It shall be appreciated that the washing machine that has been described here by mere way of example may be the subject of a number of modifications without departing from the scope of the present invention.

In particular, those skilled in the art will be fully capable of appreciating that the free connections 9 between the compartments 4 and 5 can be made in a different manner, such as for instance through the provision of air gaps, or air breaks, of a pre-established length adapted to cut off the water communication between the compartments in the case of a water flow-rate below a certain minimum value.

1. Washing machine comprising a washing-aid dispenser with a plurality of compartments connected to a washing tub, said machine being adapted to carry out successive operation phases under the control of a programme sequence control unit that is adapted to also control water-inlet valve means, characterized in that
said compartments (4, 5) of said washing-aid dispenser are connected in series with each other by connection means other than siphons,
only a first one (4) of said compartments is connected to said water-inlet valve means (11) at an inlet aperture (10) of said dispenser,
said programme sequence control unit (3) of the machine being adapted to selectively control said valve means (11) in such a manner as to let into the sole first compartment (4), during a pre-determined operation phase, a first amount and/or flow rate of water, as well as in such a manner as to let into said first compartment (4), during a subsequent operation phase, such a second amount and/or flow rate of water as to cause the same water to pass into at least another one (5) of said compartments.

2. Washing machine according to claim 1, characterized in that said connection means comprise at least a partition (9) having a pre-determined overflow level.

3. Washing machine according to claim 1, characterized in that said programme sequence control unit (3) is adapted to control said valve means (11) according to a selectively variable duty-cycle of successive openings and closures of said valve means.
